(19) United States
(12) Patent Application Publication
(10) Pub. No.: US 2020/0168065 A1
(43) Pub. Date: May 28, 2020

(54) VEHICULAR VIEWER SYSTEM AND METHOD

(71) Applicant: Jennifer Cassimy, Markham (CA)

(72) Inventor: Jennifer Cassimy, Markham (CA)

(21) Appl. No.: 16/200,395

(22) Filed: Nov. 26, 2018

(51) Int. Cl. G08B 13/196; H04N 7/18; B60R 25/10; B60R 25/30

(52) U.S. Cl. CPC G08B 13/19647; H04N 7/183; B60R 2025/1016; B60R 25/305; B60R 25/1012

(57) ABSTRACT

The vehicular viewer system includes application software in communication with a server via a communication network; an electronic device; at least one mountable camera; a sensor mechanism; and a vehicle. The vehicle viewer system includes an application software in communication with a server via communication network through an electronic device enabling a vehicle owner to remotely activate at least one mountable camera and sensor mechanism in a vehicle providing a safe and secure area in and around a vehicle by which can be remotely viewed.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of television, communications: electrical of existing art and more specifically relates to television, communications: electrical including vehicular, having plural distinct sensors (i.e., for surrounding conditions), intrusion detection, including personal portable device.

### RELATED ART

Safety is paramount for a vehicle owner and any occupants when entering and exiting a vehicle, or when traveling late at night and in a remote and isolated area. In conditions where visibility is difficult or poor, the vehicle owner may not always be able to fully view their surroundings when approaching the vehicle. Additionally, many vehicle owners are concerned that their vehicles will be broken in, vandalized or stolen while parked in a driveway, street curbside, or in a parking lot or public garage. Vehicles are equipped with conventional locks but these devices are not completely infallible. The ability to warn a vehicle owner of their immediate surroundings or existence of any danger via an electronic device is desired.

U.S. Pat. No. 9,701,265 to David S. Breed relates to smartphone-based vehicle control methods. The described method for controlling a vehicle includes a smartphone-engaging coupling element. Data about operational status of the vehicle is transferred from one or more vehicle-resident systems to a smartphone when the smartphone is engaged with the coupling element. Commands are received by the vehicle from the smartphone when the smartphone is engaged with the coupling element, which commands being based in part on data previously transferred from the vehicle-resident system(s) to the smartphone when the smartphone is engaged with the coupling element. A vehicular system, e.g., seat positioning system, mirror positioning system, passenger compartment temperature control system, route guidance or navigation system, changes its operation in accordance with the commands received by the vehicle from the smartphone when the smartphone is engaged with the coupling element.

### SUMMARY OF THE INVENTION

In view of the foregoing disadvantages inherent in the known television, communications: electrical including vehicular, having plural distinct sensors (i.e., for surrounding conditions), intrusion detection, including personal portable device art, the present disclosure provides a novel vehicular viewer system. The general purpose of the present disclosure, which will be described subsequently in greater detail, is to provide a vehicular viewer system whereby users can be content in knowing they can view their vehicle from a remote positioning.

A vehicular viewer system is disclosed herein. The vehicular viewer system includes an application software in communication with a server via a communication network; an electronic device; at least one mountable camera; a sensor mechanism; and a vehicle. The vehicle viewer system comprises an application software in communication with a server via communication network through an electronic device enabling a vehicle owner to remotely activate at least one mountable camera and sensor mechanism in a vehicle providing a safe and secure area in and around a vehicle by which can be remotely viewed. Suitable electronic and mechanical means are provided for rotating and otherwise positioning the cameras via remote control via the software on the electronic device and depending on the user manipulation.

According to another embodiment, a vehicular viewer system is also disclosed herein comprising the steps of: providing a vehicular viewer system; capturing information of vehicle surroundings; uploading and transmitting information of the vehicle surroundings to an electronic device; displaying information of the vehicle surroundings via an electronic device; notifying a vehicle owner remotely via an electronic device; and a vehicle owner analyzing information of the vehicle surroundings for a safe and secure area in and around the vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicular viewer system, constructed and operative according to the teachings of the present disclosure.

FIG. 1 is a perspective view of the vehicular viewer system during an ‘in-use’ condition, according to an embodiment of the disclosure.

FIG. 2 is a perspective view of the vehicular viewer system of FIG. 1, according to an embodiment of the present disclosure.

FIG. 3 is a perspective view of the vehicular viewer system of FIG. 1, according to an embodiment of the present disclosure.

FIG. 4 is a perspective view of the vehicular viewer system of FIG. 1, according to an embodiment of the present disclosure.

FIG. 5 is a flow diagram illustrating a method of use for the vehicular viewer system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to television, communications: electrical including vehicular, having plural distinct sensors (i.e., for surrounding conditions), intrusion detection, including personal portable device and more particularly to a vehicular viewer system as used to improve and provide a safe and secure area in and around a vehicle by which can be remotely viewed by a vehicle owner.

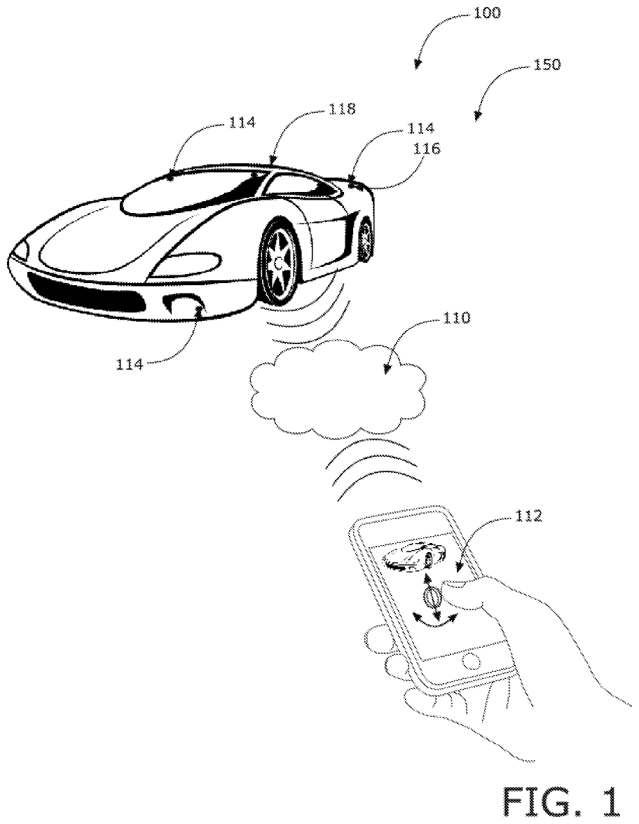

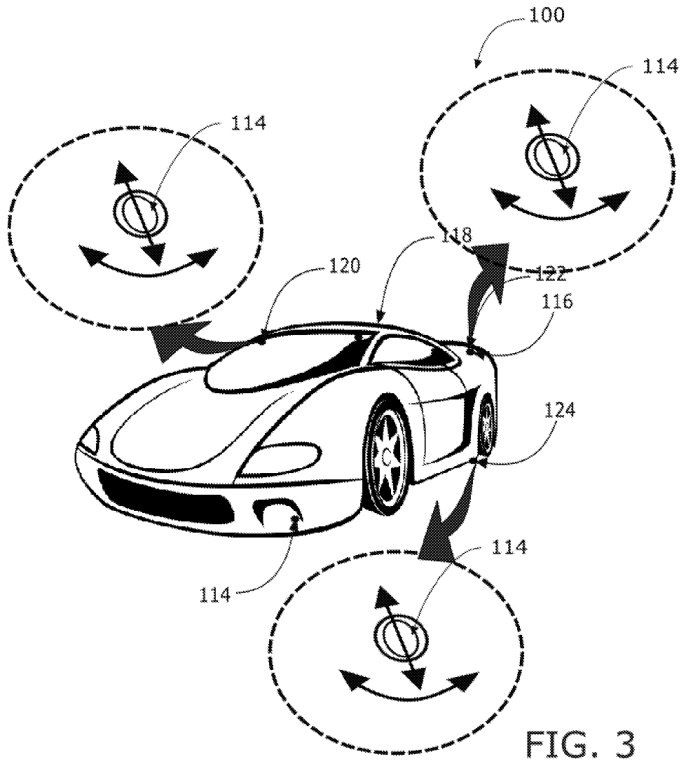

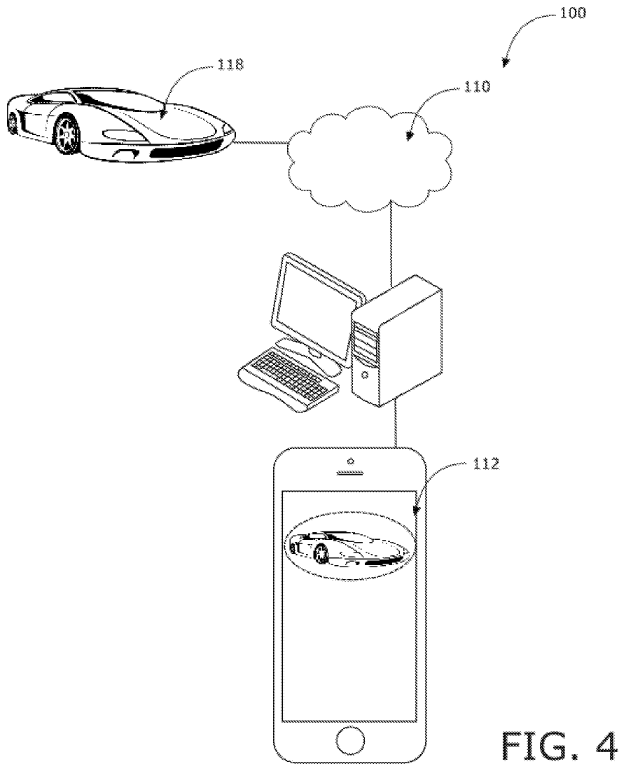

Referring now more specifically to the drawings by numerals of reference, there is shown in FIGS. 1-4 various views of a vehicular viewer system 100.

FIG. 1 shows a vehicular viewer system 100 during an ‘in-use’ condition 150, according to an embodiment of the present disclosure. Here, the vehicular viewer system 100 may be beneficial for use by a vehicle owner to provide a safe and secure area in and around a vehicle which can be remotely viewed by a vehicle owner (or to visually warn the owner if it isn't safe). As illustrated, the vehicular viewer system 100 may comprise: an application software in communication with a server via a communication network 110, an electronic device 112, at least one mountable camera 114, a sensor mechanism 116, and a (host) vehicle 118.

The vehicular viewer system 110 comprises an application software in communication with a server via a communication network 110 through an electronic device 112 and enables a vehicle owner to remotely activate at least one mountable camera 114 and a sensor mechanism 116 in a vehicle 118 wherein a safe and secure area in and around a vehicle 118 can be remotely viewed via manipulation of the at least one mountable camera 114. The application software in communication with a server via a communication network 110 provides data exchange between a vehicle owner and an electronic device 112. Additionally, an application software in communication with a server via a network 110 uses object recognition to analyze an image and store the image within an electronic device 112. As illustrated, an application software in communication with a server via a network 110 uses object recognition to analyze an image and transmit and display remotely on an electronic device 112. The electronic device 112 of the vehicular viewer system 100 is selected from the group of a smartphone, tablet, mobile phone, PC, and a mobile electronic messaging device and includes a sensor mechanism 116 and configured to capture and generate an image and store to an electronic device 112. Alternatively, the electronic device 112 is selected from the group of a smartphone, tablet, mobile phone, PC, and a mobile electronic messaging device and configured to capture and generate a video recording and store to an electronic device 112. The present invention may do create forms of media.

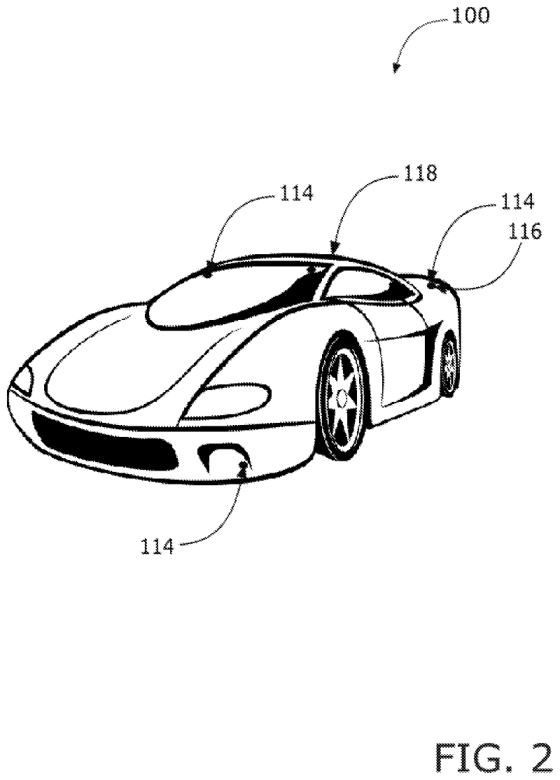

Referring now to FIGS. 2-4 showing various views of the vehicular viewer system 100 of FIG. 1, according to an embodiment of the present disclosure. The vehicular viewer system 100 comprises at least one mountable camera 114 and may comprise a plurality of mountable cameras 114. The plurality of mountable cameras 114 each provide object and movement recognition through rotation at varying degrees. Additionally, a plurality of mountable cameras 114 each provide object and movement recognition through rotation at varying degrees and provide multiple views of the interior 120 and the exterior 122 and the undercarriage 124 of a vehicle 118. Further, an application software in communication with a server via a communication network 110 provides a vehicle owner with a vehicle selection option for use with multiple vehicles and provides a vehicle owner with a vehicle selection option allowing the vehicle owner to view multiple vehicles simultaneously. A plurality of mountable cameras 114 each are mounted on the interior 120 and the exterior 122 and the undercarriage 124 of the vehicle 118.

According to one embodiment, the vehicular viewer system 100 may be arranged as a kit. In particular, the vehicular viewer system 100 may further include a set of instructions. The instructions may detail functional relationships in relation to the structure of the vehicular viewer system 100 such that the vehicular viewer system 100 can be used, maintained, or the like, in a preferred manner.

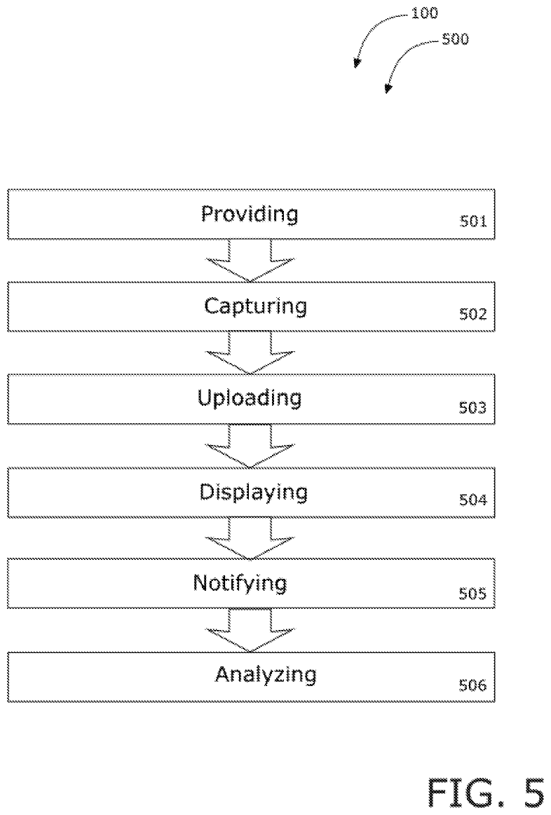

Referring now to FIG. 5 showing a flow diagram illustrating a method of use 500 for vehicular viewer system, according to an embodiment of the present disclosure. In particular, the method of use 500 may include one or more components or features of the vehicular viewer system 100 as described above. As illustrated, the method of use 500 may include the steps of: step one 501, providing a vehicular viewer system; step two 502, capturing information of vehicle surroundings via manipulation of the at least one camera; step three 503, uploading and transmitting information of vehicle surroundings via an electronic device; step four 504, displaying information of vehicle surroundings via an electronic device; step five 505, notifying a vehicle owner remotely via an electronic device; and step six 506, vehicle owner analyzing information of vehicle surroundings for a safe and secure area in and around a vehicle.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicular viewer system comprising:
an application software in communication with a server via a communication network;
an electronic device;
at least one mountable camera;
a sensor mechanism; and
a vehicle;
wherein said vehicular viewer system comprises in combination said application software in communication with a server via a communication network and said electronic device and said at least one mountable camera and said sensor mechanism and said vehicle;
wherein said vehicular viewer system comprises said application software in communication with said server via said communication network through said electronic device and enables a vehicle owner to remotely activate said at least one mountable camera and said sensor mechanism in said vehicle providing a safe and secure area in and around said vehicle by which can be remotely viewed.

2. The vehicular viewer system of claim 1, wherein said application software in communication with said server via said communication network provides data exchange between said vehicle owner and said electronic device.

3. The vehicular viewer system of claim 1, wherein said application software in communication with said server via said network uses object recognition to analyze an image and store said image within said electronic device.

4. The vehicular viewer system of claim 3, wherein said application software in communication with said server via said network uses said object recognition to analyze said image and transmit and display remotely on said electronic device.

5. The vehicular viewer system of claim 1, wherein said electronic device is selected from the group of a smartphone, tablet, mobile phone, PC, and a mobile electronic messaging device.

6. The vehicular viewer system of claim 5, wherein said electronic device is selected from said group of a smartphone, tablet, mobile phone, PC, and a mobile electronic messaging device includes said sensor mechanism and is configured to capture and generate said image and store to said electronic device.

7. The vehicular viewer system of claim 5, wherein said electronic device is selected from said group of a smartphone, tablet, mobile phone, PC, and a mobile electronic messaging device includes said sensor mechanism and is configured to capture and generate a video recording and store to said electronic device.

8. The vehicular viewer system of claim 1, wherein said at least one mountable camera comprises a plurality of said mountable cameras.

9. The vehicular viewer system of claim 8, wherein said plurality of said mountable cameras each provide object and movement recognition through rotation at varying degrees.

10. The vehicular viewer system of claim 8, wherein said plurality of said mountable cameras each provide said object and movement recognition through said rotation at said varying degrees providing multiple views of the interior, exterior and underneath of said vehicle.

11. The vehicular viewer system of claim 1, wherein said application software in communication with said server via said communication network provides said vehicle owner with a vehicle selection option for use with multiple vehicles.

12. The vehicular viewer system of claim 11, wherein said application software in communication with said server via said communication network provides said vehicle owner with said vehicle selection option allowing said vehicle owner to view multiple said vehicles simultaneously.

13. The vehicular viewer system of claim 8, wherein said plurality of said mountable cameras each are mounted on the interior of said vehicle.

14. The vehicular viewer system of claim 8, wherein said plurality of said mountable cameras each are mounted on the exterior of said vehicle.

15. The vehicular viewer system of claim 8, wherein said plurality of said mountable cameras each are mounted on an undercarriage of said vehicle.

16. The vehicular viewer system of claim 13, wherein said plurality of said mountable cameras each are mounted on the interior and exterior of said vehicle.

17. A vehicular viewer system comprising:
an application software in communication with a server via a communication network;
an electronic device;
at least one mountable camera;
a sensor mechanism; and
a vehicle;
wherein said vehicular viewer system comprises in functional combination said application software in communication with said server via said communication network, said electronic device, said at least one mountable camera, said sensor mechanism and said vehicle;
wherein said vehicular viewer system comprises said application software in communication with said server via said communication network through said electronic device and enables a vehicle owner to remotely activate said at least one mountable camera and said sensor mechanism in said vehicle providing a safe and secure area in and around said vehicle by which can be remotely viewed;
wherein said application software is in communication with said server via said communication network providing data exchange between said vehicle owner and said electronic device;
wherein said application software is in communication with said server via said network and uses object recognition to analyze an image and store said image within said electronic device;
wherein said application software in communication with said server via said network uses said object recognition to analyze said image and transmit and display remotely on said electronic device;
wherein said electronic device is selected from said group of a smartphone, tablet, mobile phone, PC, and a mobile electronic messaging device including said sensor mechanism and is configured to capture and generate said image and store to said electronic device;
wherein said electronic device is a smartphone;
wherein said at least one mountable camera comprises a plurality of said mountable cameras;
wherein said plurality of said mountable cameras each provide object movement recognition through rotation at varying degrees;
wherein said plurality of said mountable cameras each provide said object and movement recognition through said rotation at said varying degrees providing multiple views of the interior, exterior and underneath of said vehicle;
wherein said at least one camera is able to be remotely controlled via said electronic device;
wherein said application software in communication with said server via said communication network provides said vehicle owner with a vehicle selection option for use with multiple said vehicles; and
wherein said plurality of said mountable cameras each are mounted on the interior and the exterior of said vehicle.

18. The vehicular viewer of system of claim 17 wherein said vehicular viewer system comprises a kit with instructions.

19. A method of remotely monitoring and maintaining a safe and secure area in and around a vehicle which can be remotely viewing using the vehicular viewer system, the method comprising the steps of:
providing a vehicular viewer system;
capturing information of vehicle surroundings;
uploading and transmitting said information of said vehicle surroundings to an electronic device;
displaying said information of said vehicle surroundings via said electronic device;
notifying a vehicle user remotely via said electronic device; and
said vehicle user analyzing said information of said vehicle surroundings for a safe and secure area in and around said vehicle.

20. The method of claim 19 further comprising the step of remotely controlling a plurality of cameras via said electronic device.
